(19) United States
(12) Patent Application Publication
(10) Pub. No.: US 2018/0036691 A1
(43) Pub. Date: Feb. 8, 2018

(54) DEVICE FOR AERATING WINE

(71) Applicant: LINDE AKTIENGESELLSCHAFT, München (DE)

(72) Inventors: Andrew Richard Thomas Tatarek, Aldershot (GB); Thomas Bickford Holbeche, Church Crookham (GB)

(21) Appl. No.: 15/556,456

(22) PCT Filed: Mar. 9, 2016
(86) PCT No.: PCT/EP2016/000423

§ 371 Date: Sep. 7, 2017

(30) Foreign Application Priority Data
Mar. 12, 2015 (EP) 15000725.0

(51) Int. Cl. B01F 3/04; B01F 13/00; F16K 21/06; B01F 15/04

(52) U.S. Cl. CPC B01F 3/04801; B01F 15/0479; B01F 13/002; F16K 21/06; B01F 2215/0072; B01F 2003/04865; F16K 31/535

(57) ABSTRACT

The present invention relates to a wine aerating device comprising a body member (10), adapted to hold a container (12) containing pressurized gas and a lance member (14) for diffusing pressurized gas into a wine to be aerated, the body member (10) being provided with a passage (102, 103, 121, 105, 104) for passing a flow of pressurized gas from the container (12) to the lance member (14), comprising a comprising a control mechanism (23) for providing a flow of pressurized gas from the body member (10) to the lance member (14) over a variable length of time, the duration of which can be manually set by a user, wherein the control mechanism (23) comprises a valve (24), the valve being adapted to be manually actuated by rotary movement of a collar (20) provided on body member (10).

The present invention relates to a device for aerating or oxygenating wine.

Adding controlled amounts of oxygen to wine (also known as aerating the wine) is known to improve its taste. Typically, wine is aerated before use via a decanter or carafe. In a recent development wine can also be aerated using a venturi type system whereby the wine is poured from the bottle into an intermediary vessel above the wine glass, and the wine then aerated via the venturi effect as it passes from the intermediary vessel to the wine glass. Both of these aerating methods however are limited in terms of the rate of which air can be introduced into the wine.

It is also known to aerate wine using pressurized gas containing oxygen, e.g. pressurized air. A container containing pressurized gas is particularly provided as a gas cylinder. Herein, the gas from the gas cylinder is diffused into the wine in a controlled manner via a diffusion member, typically provided as a lance member.

Depending on the type of wine to be aerated, different amounts of oxygen are preferably diffused. For example, more complex red wines will usually require greater amounts of oxygen than some white wines. Therefore, it is an advantageous feature of wine aerating devices to be provided with means for controlled dosage of predeterminable amounts of oxygen.

The invention attempts to facilitate the handling of wine aerating devices in connection with dosage of oxygen.

This object is achieved with a wine aerating device according to claim 1

The wine aerating device according to the invention comprises a body member, adapted to hold a container containing pressurized gas and a diffusion member for diffusing pressurized gas into a wine to be aerated, the body member being provided with a passage for passing a flow of pressurized gas from the container to the diffusion member, and a control mechanism for providing a flow of pressurized gas from the body member to the diffusion member over a manually settable length of time.

The control mechanism comprises a valve, the valve being adapted to be manually opened and/or closed by rotary movement of a collar provided on the body member.

Manual actuation of a valve of a control mechanism allowing flow of pressurized gas into the wine to be aerated by means of a rotary movement of a collar ensures easy handling. Furthermore, by such rotary movement, the valve can easily be opened or closed, providing a reliable and robust means for dosage of oxygen.

Preferably, there is provided a spring mechanism providing a biasing force acting on the collar. By means of such a biasing force, it can be ensured that the valve, having been manually opened by rotary movement of the collar, is automatically urged back into its closed position after termination of manual actuation.

According to a preferred embodiment of the device according to the invention, the valve defines a closed position, preventing flow of pressurized gas, and an open position, allowing flow of pressurized gas, the valve being adapted for manual actuation of the collar to move it from the closed into the open position, and after termination of manual actuation for the spring mechanism acting on the collar to urge the valve back into its closed position. By means of such a spring, the time required for the valve to return from an open position to the closed position can be predetermined, thus providing an effective means of dosage of oxygen.

According to a preferred embodiment, there is provided an inlet channel and an outlet channel within the body member, the valve being provided between the inlet channel and the outlet channel, the valve comprising an eccentric groove provided in the rotary collar, manual actuation of the collar rotating the eccentric groove such that it provides a communication between the inlet channel and the outlet channel, allowing flow of pressurized gas from the inlet channel to the outlet channel. After termination of the manual actuation, the spring urges the groove back into a rotary position corresponding to the closed position of the valve, in which flow of pressurized gas is prevented.

The provision of such an eccentric groove in combination with a spring biased rotary collar provides a robust and reliable dosage means, as the duration of time before the valve moves from an open position back into the closed position can easily be set by a corresponding amount of rotary movement of the collar. For example, if the collar is manually rotated by 180°, the valve can be in its open position for about twice as long compared to a rotary movement by 90°. Also, such an eccentric groove allows continuous setting of a desired duration of time, during which the valve shall remain in its open position.

According to another preferred embodiment the valve is not rotatable with rotary collar. Instead, it has an axial movement perpendicular to the axis of the body member to open or close the communication between the gas inlet channel and outlet channel. The axis of the body member is the axis of rotation which has preferably a direction from gas inlet to gas outlet. Preferably, the valve is positioned perpendicular to the axis of the body member. The valve comprises a shaft having a first end and a second end. The first end is connected to a spring which provides a biasing force towards the second end of the shaft to the rotary collar. The second end of the shaft is pressed radially on the rotary collar by the biasing force of the spring. The first end has preferably a larger cross-section than the second end of the shaft.

The valve is preferably provided with a chamber which provides a communication between the gas inlet and the gas outlet. The spring and at least the first end of the shaft are positioned in the chamber. The pressurized gas flows into the chamber through the gas inlet channel and flows subsequently from the chamber to the gas outlet channel over the valve. The chamber has larger cross-section on the side of first end of the shaft than it of the second end of the shaft. At least one first gasket is provided between the chamber and shaft, preferably at the narrowing of the cross-section of the chamber to close or open the communication between the gas outlet and the chamber by being compressed or decompressed. By controlling the compression of the first gasket the pressurized gas can be released in a controllable manner. The first gasket is preferably formed as an O-ring located in a groove of the shaft.

According to a preferred embodiment a recess is provided on the rotary collar. As described above the second end of the shaft is pressed radially on the collar. The collar rotates by the manual actuation while the shaft stays fixed, thus a circumference orbit of the second end of the shaft is formed on the collar. The recess is positioned in this orbit of the collar and is sized at least so large that the second end of the shaft can be fitted into it. Once the collar is automatically urged back into the closed position which means the collar rotates to the position at which the second end of the shaft is pressed into the recess of the collar by the force of the spring connected to the first end of the shaft, the first gasket between chamber and shaft is compressed by the geometry of the narrowing of the chamber to close the communication between gas inlet and outlet. The recess is preferably formed by a curved surface so that the second end of the shaft can be easily removed out of the recess by the manually actuation.

Advantageously, the shaft is cone-like shaped and is arranged perpendicular to the axis of the body member. The cross-section of the shaft gets smaller in direction from the first end to the second end of the shaft.

Preferably, at least one second gasket is provided between the shaft and the chamber. Unlike the first gasket the second gasket is not located between the gas outlet and the gas inlet channel and thus does not have the function to open or close the communication between the gas inlet and outlet. The second gasket is always gas-tight to ensure that the pressurized gas flow only to the gas outlet channel but not through the gap between the shaft and the chamber to outside. The second gasket is preferably formed as an O-ring located in a groove of the shaft.

According to the preferred embodiment the open position is reached by the manual rotary actuation which pushes the shaft radially in direction of the spring to open the communication between gas inlet and outlet by having the first gasket uncompressed. Due to the spring mechanism the collar is automatically urged back to the original position which is also the closed position. During the returning process the first gasket remains uncompressed for a certain period of time which depends on how far the collar is rotated. The closed position is reached when the collar is urged back to the position at which the second end of the shaft falls into the recess. The first gasket then reaches the narrowing of chamber and is thereby compressed at the narrowing of the chamber to close the communication between gas inlet and outlet.

Advantageously, the device is provided with a damping mechanism. Such a damping mechanism can, for example, be provided as a rotary damper, utilizing voids filled with viscous fluid, for example silicone oil.

Such a damping mechanism counteracts the biasing force of the spring thus providing a slow adjustable linear reaction. Depending on the biasing force exerted by the spring and the damping force exerted by the damping mechanism, various ranges, within which opening durations of the valve can be set, can be provided.

Advantageously, the damping mechanism is provided with a toothed gear, which engages with a corresponding toothed gear of the rotary collar. Hereby, a direct and thus mechanically reliable connection between the rotary movement of the collar and the damping mechanism is provided.

Advantageously, the device according to the invention is provided with a gauge mechanism. Such a gauge mechanism allows easy setting and reading of a measure of rotation or movement of the collar. Advantageously, such a gauge mechanism can be provided with a scale indicating time durations, during which the valve will remain in its open position, and/or corresponding amounts of oxygen flowing through the valve. Preferably the maximum time duration which could be set by the manual actuation is 600 seconds, preferably 300 seconds, more preferably 150 seconds. Preferably the angle from the closed position to the furthest open position is not more than 360°, more preferably not more than 330°.

Advantageously, the device is portable and able to release a pressurized gas having a pressure of 20 bars to 300 bars, preferably of 150 bars to 200 bars with a flowrate of 50 ml/min to 200 ml/min

Preferably, the device can supply between 3-10 mg O₂/l wine with a flow rate of 100 ml/min in a period of 30 seconds to 120 seconds, preferable a period of 80 seconds to 120 seconds.

The invention will now be further described with reference to the following figures, in which:

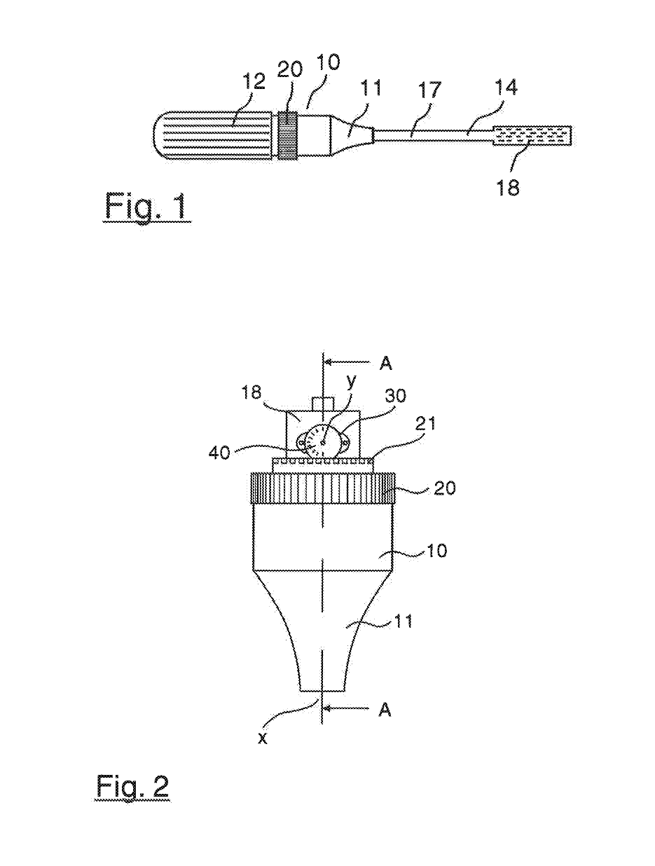

FIG. 1 shows a plan view of a preferred embodiment of an aerator device according to the invention,

FIG. 2 shows a plan view of a preferred embodiment of a body member of an aerator device according to the invention,

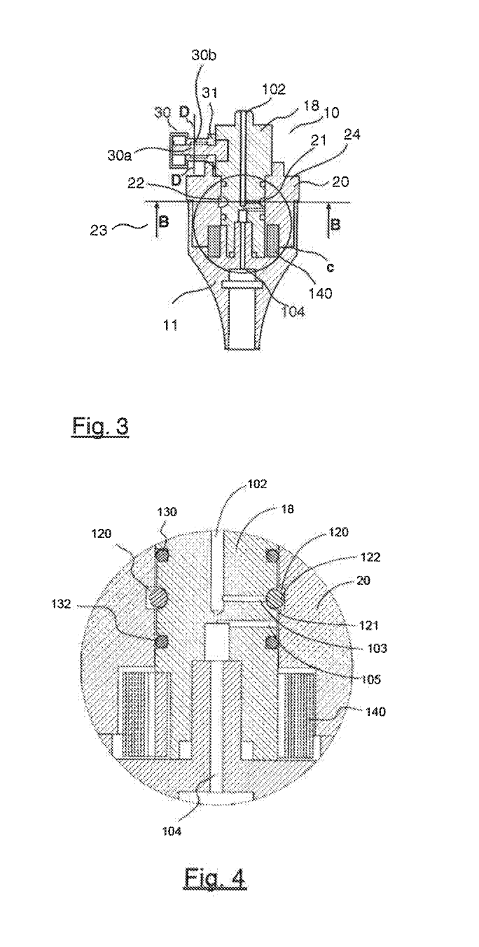

FIG. 3 shows a sectional view of the body member of FIG. 2, along cutting plane line A-A of FIG. 2,

FIG. 4 shows an enlarged view of section C of FIG. 3, showing the valve in a closed position,

FIG. 5 shows section C of FIG. 2 in an open position of the valve,

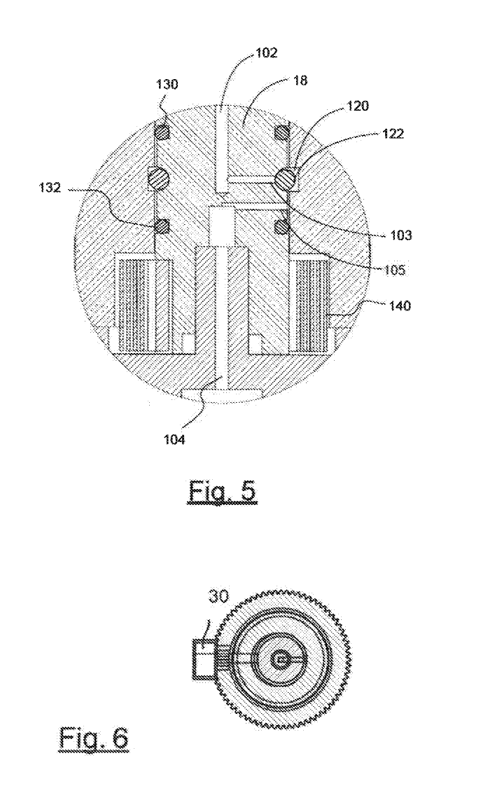

FIG. 6 shows a sectional view along cutting plane line B-B of FIG. 3,

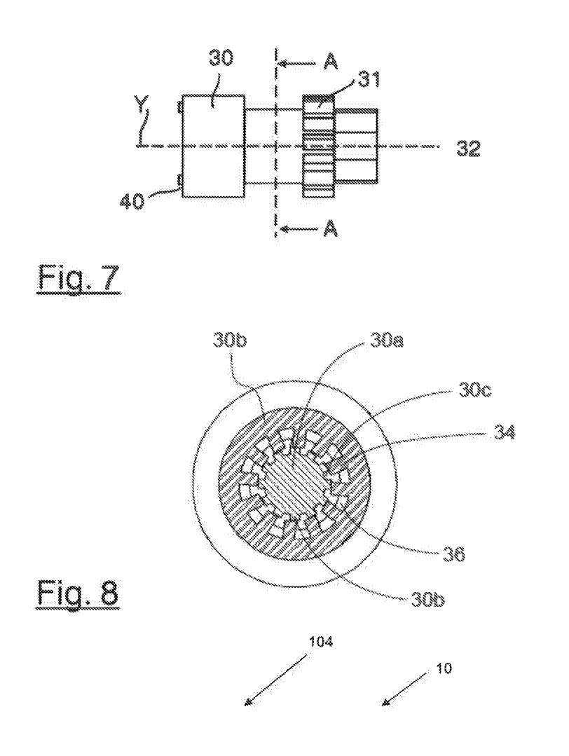

FIG. 7 shows an enlarged view of a damping mechanism used in connection with the present invention, and

FIG. 8 shows a sectional view along cutting plane line A-A of FIG. 7.

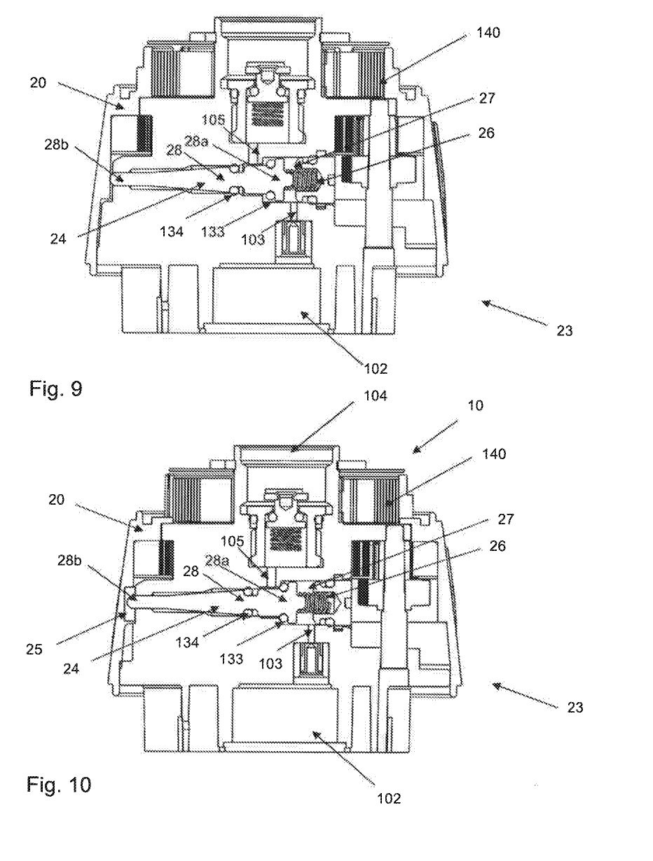

FIG. 9 shows a sectional view of a preferred embodiment of a body member of an aerator device according to the invention in which a valve is present in an open position.

FIG. 10 shows a sectional view of the preferred embodiment of FIG. 9 having the valve in a closed position

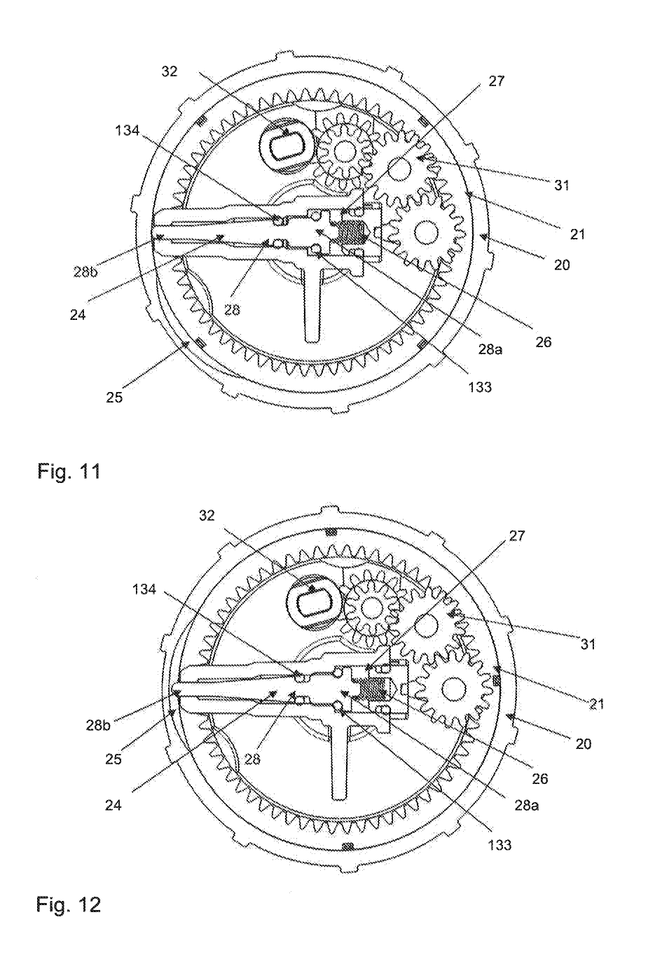

FIG. 11 shows a top view of the preferred embodiment of FIG. 9

FIG. 12 shows a top view of the preferred embodiment of FIG. 10

The aerating device shown in the figures comprises a body member 10 adapted to hold a gas cylinder 12 and a diffusion member 14. In the embodiment shown, the diffusion member 14 is provided as a diffusion lance comprising a tube 17, which connects to body member 10, and a diffuser body 18.

The lance is arranged downstream of the body member 10. Here and in the following, the term “downstream” shall mean towards the diffusion member end of the gas path, and the term “upstream” towards the cylinder or handle end of the gas path.

The body number 10 comprises a core part 18, a collar 20, which is manually rotatable about the core part 18, and an interface 11 (see especially FIG. 3).

In use, the device is arranged to engage with the neck of a wine bottle, which e.g. has a fluid content of 75cl (not shown), via the interface 11.

The interface 11 also connects the body member 10 to diffusion member 14. The interface 11 forms a conical shape, which is dimensioned to fit inside or on the neck of a wine bottle.

The core part 18 is provided in a rotationally fixed manner with respect to interface 11. The collar 20 is rotatable relative to core part 18 and interface 11 about a longitudinal axis X indicated in FIG. 2. The collar 20 is part of a control mechanism 23 for providing a flow of pressurized gas (received from gas cylinder 12) from the body member 10 to diffusion member 14, which will now be further explained with reference to FIGS. 2 to 7.

FIG. 2 shows a preferred embodiment of a body member 10, which can be used in connection with the aerating device of FIG. 1. FIG. 3 shows a sectional view along line A-A of FIG. 2. FIGS. 4 and 5 show section C of FIG. 3 in an enlarged view. FIG. 6 shows a sectional view along line B-B of FIG. 3. FIGS. 7 and 8 show further details relating to a damper mechanism and a gauge member, which will be further explained below.

The body member 10 is provided with an inlet channel 102 within core part 18 communicating with gas cylinder 12, and with an outlet channel 104 within interface 11, communicating with diffusion member 14, Between inlet channel 102 and outlet channel 104, there is provided a valve, generally designated 24, which is also part of the control mechanism 23. The valve 24 is provided in section C of the body member, which is shown in greater detail in FIGS. 4 and 5.

Inlet channel 102 is provided with an inlet branch-off 103, which is in communication with an eccentric groove 120 formed on the inside of collar 20 (see FIGS. 4 and 5). Eccentric groove 120 communicates with an annular gap 121 provided between core part 18 and collar 20. Annular gap 121 communicates with a branch-off 105 of outlet 104.

In the positions shown in FIG. 4, any flow of pressurized gas from inlet 102 to outlet 104 is prevented by an O-ring 122 provided in eccentric grove 120, which is in a state of compression due to the dimensioning of eccentric groove 120. As can be seen in FIG. 4, the width of eccentric groove 120 is somewhat larger in the region diametrally opposed to the branching-off channels 103, 105.

By rotating collar 20 about core part 18 (i.e. axis X), the section of eccentric groove 120 with greater width can be brought into alignment with branching-off channel 103. This situation is depicted in FIG. 5. It can be seen that O-ring 122 is no longer compressed and can be displaced in case of pressurized air impinging on it through inlet 102 and branching-off channel 103. Thus, in the situation depicted in FIG. 5, pressurized air from inlet 102 can pass through branching-off channel 103, eccentric groove 120, annular gap 121, branching-off channel 105 and into outlet 104, and thus into diffusor member 14.

In order to ensure a stable rotary movement of collar 20 relative to body member 10 and to provide a seal within annular gap 121, further O-rings 130, 132 can be provided.

In principal, the collar 20 can be manually held in the position shown in FIG. 5 as long as a user wishes, and then be manually rotated back into the position shown in FIG. 4.

However, it is preferable to make use of a spring mechanism 140 provided between core part 18 and collar 20, which urges the collar back from the open valve position shown in FIG. 5 to the closed valve position shown in FIG. 4. By means of this spring mechanism acting on rotary collar 20 to provide a biasing force, and urging it back into the valve closed position, a duration of time, during which the valve 23 shall be in its open position, can easily be set depending on the extent of rotary displacement of the collar 20.

In order to achieve greater flexibility in connection with setting specific time durations, during which the valve remains open a damper mechanism 30 is provided, which will be explained in the following. By means of such a damper mechanism the range of time, over which the valve can remain in its open state, can be significantly extended and/or more exactly set.

The damper mechanism 30 comprises a non-rotary central member 30a, and a rotary member 30b, rotatable about non-rotatable member 30a (see FIG. 7). On its outside, rotary member 30b is provided with a toothed gear 31 (see FIG. 7). Toothed gear 31 engages a toothed gear 21 provided on rotary collar 20 (see FIG. 3). On its inside, rotatable member 30b is provided with damper vanes 34, with corresponding voids 36 therebetween.

Non-rotatable member 30a is provided in a toothed manner, with teeth 30b and corresponding voids 30c therebetween. Voids 36 and voids 30c are filled with a viscous fluid, for example silicone oil.

In case of collar 20 being manually actuated (rotated), a corresponding rotary movement of rotary member 30b is effected via the interaction between toothed gears 21, 31. After termination of manual actuation, the interaction between damper vanes 34 and the viscous fluid provided in voids 30c, 36 counteracts the biasing force of spring 140, thus slowing down movement of the rotary collar 20 and thus valve 23 back into its closed position.

The axis of rotation of toothed gear 21 and thus rotary member 30a (designated Y in FIGS. 2 and 7) is vertical to the axis of rotation X of toothed gear 21 provided on the rotary collar 20.

Preferably, the damping action is provided to be directionally unilateral, e.g. by providing a (not shown) ratchet mechanism.

Preferably a gauge 40 is provided on the face of the damping mechanism (see FIGS. 2 and 7), which is visible to a user. By using such a gauge provided with an expediently chosen scale (e.g. time scale), a desired duration during which the valve remains open can easily be set. The calibrated scale may also be provided around the manual actuating collar.

FIG. 9 shows another preferred embodiment of a body member of the device according to the invention. The body member 10 comprises a gas inlet channel 102, a gas outlet channel 104 and a collar 20 which is manually rotatable. Between the gas inlet channel 102 and the gas outlet channel 104 a valve 24 is provided, which is part of the control mechanism 23.

The valve 24 comprises a shaft 28, a chamber 27 and a spring 26, The shaft 28 is cone-like formed and is positioned perpendicular to the axis of the body member 10. It has a first end 28a and a second end 28b wherein the first end 28a is engaged with a spring 26 and the second end 28b is pressed on the collar 20 by the biasing force of spring 26. The chamber 27 is sized to accommodate the spring 26 and the shaft 28a and it has a larger cross-section in direction of the first end 28a than it in direction of the second end of the shaft 28b. A sharp narrowing of the chamber is thereby formed as shown in the figure.

Inlet channel 102 is provided with an inlet branch-off 103, which is in communication with the chamber 27 and the chamber 27 communicates with an outlet branch-off 105 of outlet channel 104. The chamber 27 enables thereby a communication between the gas inlet and the gas outlet.

At least one first gasket 133 is provided between the chamber 27 and the shaft 28 which is located between the inlet branch-off 103 and the outlet branch-off 105 to open or close the communication between gas inlet and outlet. The first gasket 133 is formed as an O-ring siting in a groove of the shaft 28.

At least one second gasket 134 is provided between the chamber 27 and the shaft 28. Unlike the first gasket 133 the second gasket 134 is not located between the gas inlet and outlet channel. Therefore it does not have the function to open or close the communication between the gas inlet and outlet. The second gasket 134 act always gastight to prevent the gas flowing through the gap between the chamber 27 and the shaft 28 to outside. The second gasket 134 is formed as an O-ring siting in a groove of the shaft 28.

The valve 24 shown in the figure is in an open position. As can be seen the first gasket 133 is uncompressed which enable the pressurized gas flow from the gas inlet channel 102 through the chamber 27 and outlet branch-off 105 to the gas outlet channel 104. In the open position of the valve 24 the spring 26 stays compressed by the shaft 28 which makes the first gasket 133 not be compressed to allow the pressurized gas flow therethrough. This open position is achieved by rotating the collar 20 manually against the spring mechanism to keep the shaft 28 pressing on the spring 26. The first gasket 133 remains uncompressed as long as the spring 26 keeps compressed by the shaft 28.

FIG. 10 shows the valve in a closed position. Due to the spring mechanism 140 the rotated collar 20 is automatically urged back to the original position which is also the closed position. In this position the shaft 28 is pushed into a recess 25 in the collar 20 by the force of the compressed spring 26 which compresses the first gasket 133 at the narrowing of the chamber 27. The first gasket 133 is compressed by the spring 26 and the geometry of the narrowing of chamber 27 to prevent the pressurized gas flowing from the chamber 27 to the outlet branch-off 105. The recess 25 is preferably formed with curved surface so the shaft 28 can be easily removed out of the recess 25 to open the valve by manually actuation on the collar 20.

FIG. 11 shows a top view of the body member in FIG. 9 in which the valve 24 is in the open position. As can be seen the first gasket 133 is uncompressed to allow the gas flow through. The collar 20 is provided with a gear 2. The non-rotatable core part of body member comprises one or several gears 31 which have a function of transmission to transfer the rotation of the collar 20 to a faster rotation at the end of the transmission. A rotary damping mechanism 32 is provided at the end of the transmission which provides a counterforce to the biased spring mechanism to secure a slow and stable rotation of the collar 20 back to the closed position by its damper function.

FIG. 12 shows a top view of the body member in FIG. 10 in which the valve 24 is in the closed position. The valve 24 falls into the recess 25 by the spring 26 which compresses the first gasket 133 at the narrowing of the chamber 27 as to close the communication between the chamber 27 and the gas outlet(not shown here) to prevent the pressurized gas flowing out.

1. A wine aerating device comprising a body member, adapted to hold a container containing pressurized gas and a lance member for diffusing pressurized gas into a wine to be aerated, the body member being provided with a passage for passing a flow of pressurized gas from the container to the lance member, comprising a control mechanism for providing a flow of pressurized gas from the body member to the lance member over a variable length of time, the duration of which can be manually set by a user,
characterized in that the control mechanism comprises a valve, the valve being adapted to be manually actuated by rotary movement of a collar provided on body member.

2. The device according to claim 1, wherein there is provided a spring mechanism providing a biasing force acting on the collar.

3. The device according to claim 2, wherein the valve defines a closed position, preventing flow of pressurized gas, and an open position, allowing flow of pressurized gas, the valve being adapted for being actuated by rotary movement of the collar from the closed position into the open position, and after termination of manual actuation to be urged back into the closed position by means of the spring mechanism acting on the collar.

4. The device according to claim 1, wherein there is provided an inlet channel and an outlet channel in the body member, the valve being provided between the inlet channel and the outlet channel, the valve comprising an eccentric groove provided in the rotary collar, manual actuation of the collar rotating the eccentric groove such that it provides a communication between the inlet channel and the outlet channel, allowing flow of pressurized gas from the inlet channel to the outlet channel.

5. The device according to claim 1, wherein there is provided an inlet channel and an outlet channel in the body member, the valve being provided between the inlet channel and the outlet channel, the valve comprising a shaft having a first end and a second end, wherein the first end is connected to a spring providing a biasing force in direction perpendicular to the axis of the body member and the second end is arranged to radially touch the rotary collar, wherein the first end has a larger cross-section than the second end of the shaft.

6. The device according to claim 5, wherein the valve comprises a chamber to accommodate the spring and the shaft which provides a communication between the gas inlet channel and the gas outlet channel, wherein at least one first gasket is provided between the chamber and the first end of the shaft, wherein the chamber comprises a cross-section-narrowing by which the first gasket can be compressed to close the communication.

7. The device according to claim 5, wherein a recess is provided on the rotary collar to define the closed position of the valve by pushing the second end of the shaft into the recess to get the first gasket compressed.

8. The device according to claim 5, wherein the shaft is cone-like shaped and is arranged perpendicular to the axis of the body member.

9. The device according to claim 5, wherein at least one second gasket is provided between the shaft and the chamber to prevent the pressurized gas escaping from the gap between the shaft and the chamber.

10. The device according to claim 1, comprising a damping mechanism.

11. The device according to claim 10, wherein the damping mechanism is provided with a toothed gear, which engages with a corresponding toothed gear provided on the rotary collar.

12. The device according to claim 1, provided with a gauge mechanism.

13. The device according to claim 12, wherein the gauge mechanism comprises a scale.

14. The device according to claim 13, wherein the scale is provided as a calibrated scale.

15. The device according to claim 1, wherein the device is portable.
